(19) United States
(12) Patent Application Publication
(10) Pub. No.: US 2007/0086585 A1
(43) Pub. Date: Apr. 19, 2007

(54) Multi-Media Service Interface Layer

(75) Inventors: Martin Rex Dorricott, Basingtoke (GB); Douglas Angus Murrey Webster, Trowbridge (GB)

Correspondence Address: McGUINNESS & MANARAS LLP, 125 NAGOG PARK, ACTON, MA, 01720, US

(73) Assignee: Exony Ltd.

(21) Appl. No.: 11/461,009

(22) Filed: Jul. 31, 2006

Related U.S. Application Data
(60) Provisional application No. 60/779,211, filed on Mar. 3, 2006.
(60) Provisional application No. 60/722,683, filed on Sep. 30, 2005.

(51) Int. Cl. H04M 3/00

(52) U.S. Cl. 379/265.01

(57) ABSTRACT

An architecture for providing multi-media service to a client includes a web page host server for providing pages of information capable of display by a client browser, and a contact center platform capable of establishing communication between a representative and the client via telephone. At least one of the pages provided by the host server includes an indication of service options available from the contact center platform, and further includes an indication of delay associated with provision of one of those service options. In response to selection of one of the callback options by the customer, the customer is placed in a virtual callback queue in the contact center platform. Selected customer data including phone number is then provided to the contact center platform for use in establishing the callback and providing the customer service representative with information in order to avoid duplicative gathering of particular information. In an alternative embodiment, the callback service information may be delivered in a summary format to a device configured to receive and render the information in that format. For example, rather than delivering an entire HTML page with an icon including a presentation of the data, the service strategy server may simply deliver the callback delay data with a tag indicative of the service type.

### CROSS-REFERENCE TO RELATED APPLICATIONS

A claim of priority is made to U.S. Provisional Patent Application Ser. No. 60/779,211, entitled A NOVEL ARCHITECTURE AND ALGORITHMS FOR MULTI-MODAL CUSTOMER SERVICE, filed on Mar. 3, 2006, which is incorporated herein by reference, and U.S. Provisional Patent Application Ser. No. 60/722,683 entitled CALL CENTER CONFIGURATION TOOL, filed Sep. 30, 2006, which is incorporated by reference.

### FIELD OF THE INVENTION

This invention relates generally to the field of electronic customer service, and more particularly to integrating network communication tools to enhance the efficiency and capabilities of electronic customer service.

### BACKGROUND OF THE INVENTION

Electronic customer service is currently conducted via a variety of modes of network communication including the telephone and the Internet, although those technologies have some overlap. However, electronic customer service delivery is basically mono-media. In particular, the electronic customer service infrastructure is so fragmented that the different media cannot easily be used together or with traditional modes of customer service such as in-person transaction in a store. Because service delivery is mono-media, it is difficult to steer a customer between modes in order to match the strength of a given media with a particular service request. Similarly, it is difficult to adjust media selection based on real-time changes in resource availability. Another consequence of mono-media service delivery is that the quality of a given service across modes may vary considerably. There may also be duplicated efforts in maintaining and upgrading capabilities across media.

Examples of the problems generally described above are well known to many consumers. When contacting a company by telephone one is typically challenged by two or more levels of menus from which to select the appropriate path for a desired service. Navigating the menus can be tedious, and typically results in being placed in a queue. Often, the queue length in terms of time is inaccurately estimated, or not estimated at all. Since a great deal of time can be wasted while in the queue, it is difficult to know whether it is more efficient to wait in the queue or phone again later. When a company representative is finally reached, the consumer may find that the telephone is an inadequate mode of service delivery, e.g., where the consumer is being guided through a highly technical procedure for which the nomenclature of the technology is unknown to the consumer. Similarly, in the case of Internet based customer service it is not uncommon to spend considerable time navigating a web site only to find that a given service request cannot be satisfied via the web site. For example, differences between similar products may not be readily apparent from the available descriptions.

Some solutions to the problem have been attempted. For example, web collaboration is a technique whereby an application is downloaded to a customer's PC to enable a customer representative to drive the customer's web session. While this can free the consumer from the burden of executing highly technical procedures the web collaboration technology appears to be viewed by customers as unacceptably intrusive or complicated based on the slow rate of adoption. Further, having the web session driven by the customer representative is not particularly useful where the desired service request cannot be satisfied by the web site. It is also known to raise a chat session with a customer representative. However, chat sessions tend to be terse and impersonal, often leaving a customer with an unsatisfactory experience. It is also known to raise a callback via a web site. However, callback sessions typically involve delay, which also leaves the customer with an unsatisfactory experience.

### SUMMARY OF THE INVENTION

In accordance with one embodiment of the invention, apparatus for providing multi-media service to a client, comprises: a first networked device operative to provide information capable of being rendered in human-understandable form by a second networked device; and a contact center platform operative to facilitate establishment of communication between a representative and the client via a third networked device; wherein at least some of the information provided by the first networked device includes an indication of available service options, and further includes an indication of delay associated with provision of one of those service options.

In accordance with an alternative embodiment of the invention, a computer program product, on computer readable media, for providing multi-media service to a client, comprises: hosting logic executed by a first networked device operative to provide information capable of being rendered in human-understandable form by a second networked device; and contact center logic operative to facilitate establishment of communication between a representative and the client via a third networked device; wherein at least some of the information provided by the hosting logic includes an indication of service options available from the contact center logic, and further includes an indication of delay associated with provision of one of those service options.

In accordance with still another embodiment of the invention, apparatus for providing multi-media service to a client, comprises: a hosting device operative to provide tagged data; a client device operable to render the tagged data in visual form based on tags; and a contact center operative to facilitate establishment of communication between a representative and the client via telephone; wherein the visually rendered data includes an indication of service options available from the contact center, and further includes an indication of delay associated with provision of one of those service options.

In accordance with another embodiment of the invention, a computer program, stored on computer readable media, for facilitating configuration of a customer interaction script for a contact center, comprises: logic for graphically displaying, in a first portion of a page, and accepting input indicative of direction of, incoming calls via a plurality of modules; and logic for graphically displaying, in a second portion of the page, and accepting input indicative of configuration of individual ones of the modules.

One advantage of the invention is that the consumer is empowered to select the media via which customer service is delivered based on resource capability. Sometimes only one particular media will suffice for a particular customer service task. However, some customer service tasks may be performed via different media, with some being preferred by a consumer over others. The consumer may nevertheless opt for a non-preferred media if the preferred media is not readily available. Consequently, consumer experience and satisfaction are enhanced by helping to avoid long delays to service delivery.

Another advantage of the invention is enhanced customization of service offerings; both from the perspective of the consumer and the vendor. Contextual information regarding the consumer may be obtained from various sources, including but not limited to entry point, specifically selected links, session information, cookies, Google traces, in-flight transactions, and consumer identification. The contextual information can then be utilized to tailor the service offering based on the contextual information, e.g., by emphasizing media or modes of communication known to be preferred by the consumer, or by eliminating some of the information gathering typically required to respond to an inquiry, thereby enhancing the consumer experience. From the perspective of the vendor, contextual information can be used to advantage by giving priority to some consumers over others based on, for example, a calculation based on contextual information of which consumer is most valuable or most likely to purchase goods or services. A vendor might wish, for example, to move an inquiry about a new home mortgage loan ahead of an inquiry about the status of an escrow account associated with an existing home mortgage loan.

### BRIEF DESCRIPTION OF THE FIGURES

FIG. 1 is a block diagram of layers in an electronic customer service infrastructure, including a multi-media service interface layer.

FIG. 2 illustrates a network configured to support electronic customer service, including distribution of multi-media service interface layer applications.

FIG. 3 illustrates the architecture and modules of the multi-media service interface layer.

FIGS. 4 and 5 illustrate click-to-call interface features generated by the multi-media service interface layer for service delivery.

FIG. 6 illustrates an alternative embodiment of service delivery.

FIG. 7 illustrates an interface for generating the customer interaction script of the multi-media service interface layer.

### DETAILED DESCRIPTION

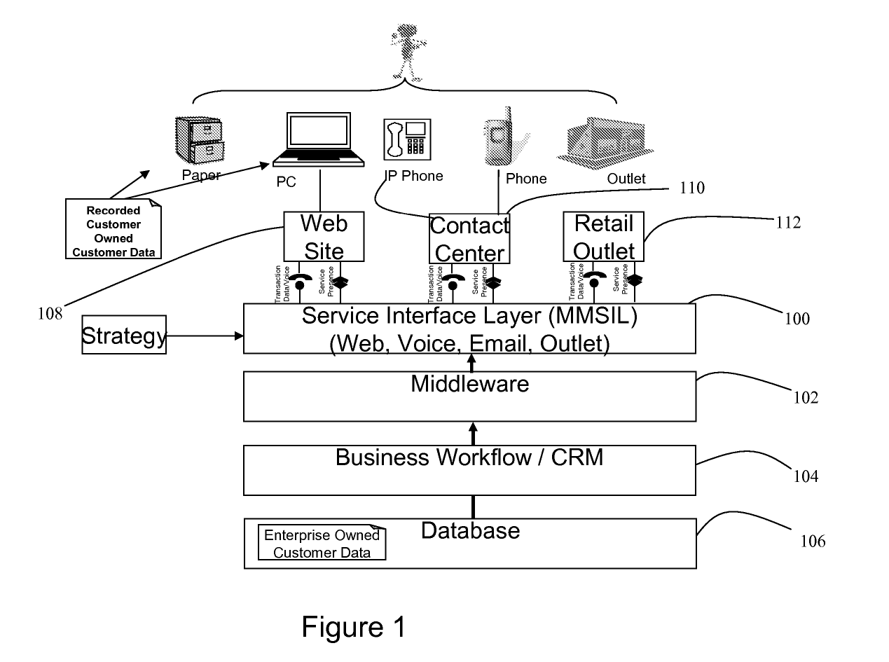

Referring to FIG. 1, a layer-model for supporting integrated, multi-media customer service, both electronic and otherwise, includes a multi-media service interface layer (“MMSIL”) (100) disposed logically between a back-end system and infrastructure associated with different media types for customer service. The back-end system may include a middleware layer (102), a business workflow/CRM layer (104) and a database layer (106). The media types for customer service may include video, audio, text, interactive web pages, paper and in-person service. A web site (108) on the Internet, a contact center (110) available via telephone, and a retail outlet (112) staffed with personnel and equipped with interactive terminals are examples of how the different media types may be delivered. In other words, the same vendor may be contacted via the web site, telephone and retail outlet. The MMSIL (100) facilitates service provision by integrating the media types, e.g., by providing telephone service in response to an initial web site contact.

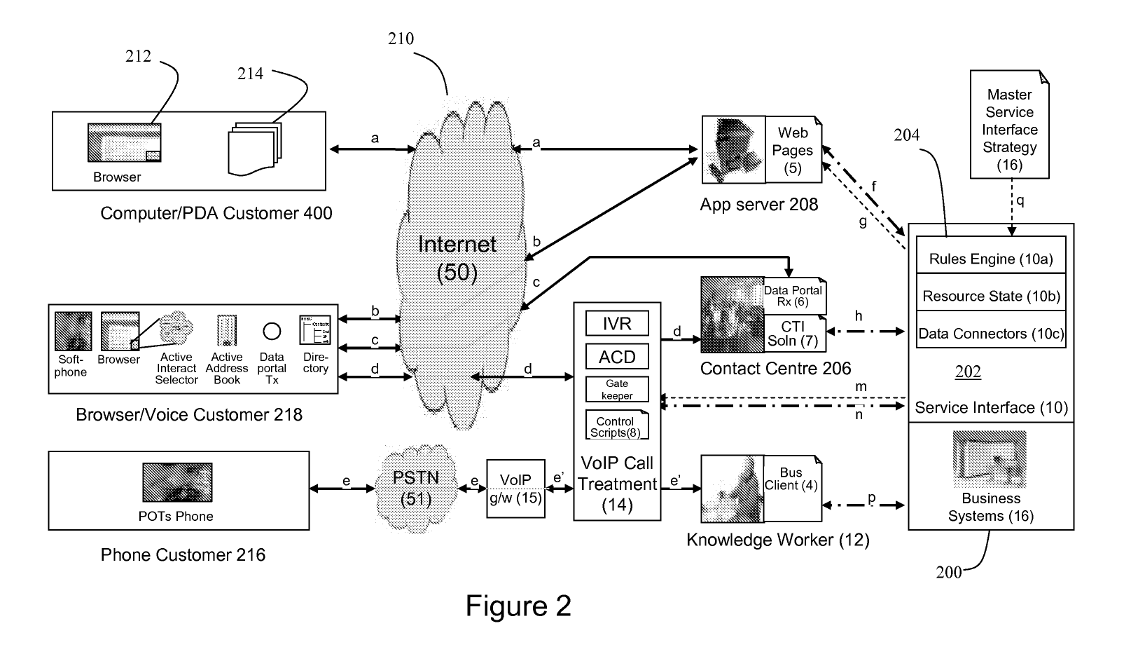

As shown in FIG. 2, a customer can be characterized according to an initial means of contact. For example, a PC customer (400) would establish contact via a computer or PDA using an application (214) such as a browser (212). A phone customer (216) would establish contact via a telephone device such as a land line or mobile phone. A browser/voice customer (218) would establish contact via a computer, via any of a soft phone, browser or other application, address book, data portal or directory. As shown by interconnecting arrows, incoming communications are at least initially directed in accordance with how the customer is characterized, e.g., via the Internet (50) to application server (208), contact centre (206), or VoIP call treatment (14), or alternatively via the PSTN (51) to VoIP gateway (15), to VoIP call treatment (14), and then to a knowledge worker (12).

Different applications and portions of applications of the MMSIL are distributed across, and executed on, various devices in the network in order to achieve the desired result of integrating the different media types for providing customer service. A service strategy server (200) includes a service interface (202) with a rules engine (204) and storage. A contact center platform (206) and applications server (208) each include control and interface applications. The control and interface applications of the contact center server and web site server are operable to control calls and web sessions, respectively, under the direction of the service strategy server (200). The service strategy server interacts similarly with a console of the knowledge worker (12). If the contact center server and application server are third party equipment with adequate functionality, the MMSIL applications may be executed substantially or entirely on the service strategy server.

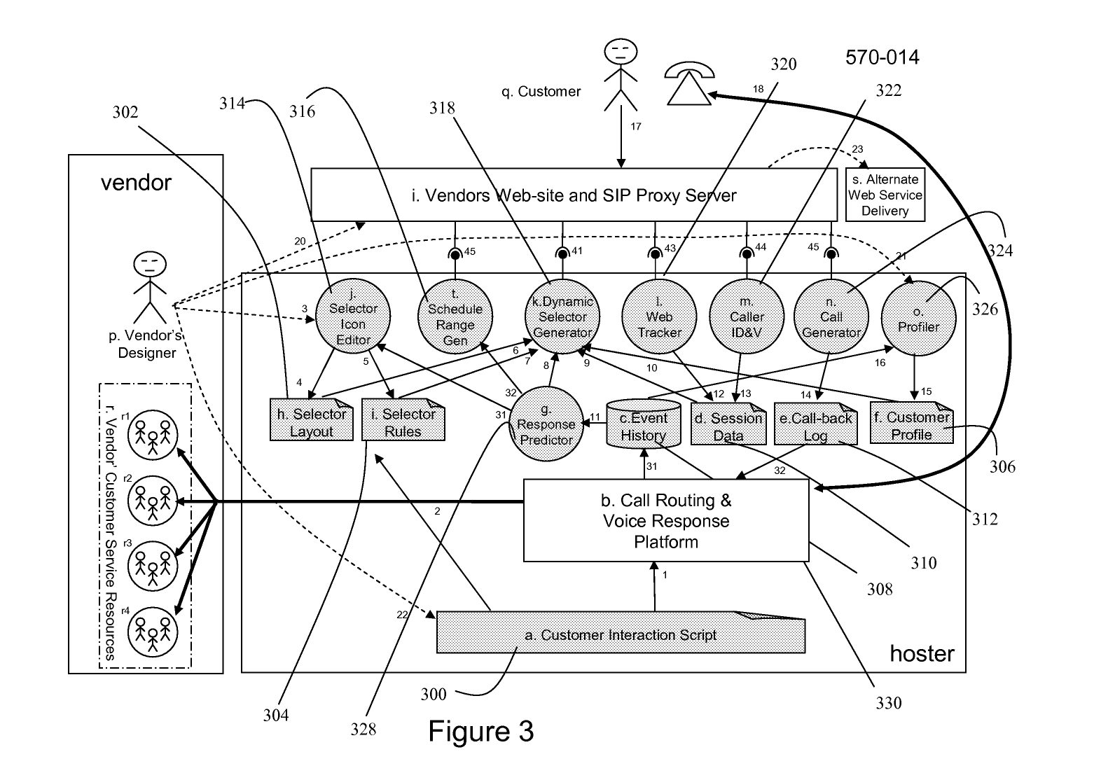

FIG. 3 illustrates the MMSIL applications independent of distribution across network devices. The MMSIL applications include configuration information modules such as a customer interaction script (300), selector layout (302), selector rules (304), and customer profile (306). The MMSIL application further includes state storage such as event history (308), session data (310) and callback log (312). Further, the MMSIL applications include a selector icon editor module (314), a schedule range generator module (316), a dynamic selector generator module (318), a web tracker module (320), a caller ID&V module (322), a call generator module (324), a profiler module (326), and a response predictor module (328). The callback log (312) includes a virtual queue of customers waiting for callback service in response to web site input. The expected time to callback for each entry in the queue is calculated by the response predictor module (328) based on data from the voice response platform (330) and the event history (308). For example, the event history may maintain data indicative of the number of callers queued for callback by subject matter, the number of available representative with knowledge of the subject matter, the future availability of those representatives, average call time, time of day and other factors which may be useful in calculating expected time to callback, i.e., the delay. The dynamic selector generator module (318) is operable to provide an indication of callback delay to prospective customers, i.e., before the customer has requested callback service. Callback delay may be calculated and presented separately for each of multiple service types. Further, the presentation may be modified by the dynamic selector generator module based on the delay. For example, if the delay for a particular service type callback exceeds a predetermined threshold then the dynamic selector generator may temporarily cease display of that callback option, or direct inquiries to some alternative resource such as a FAQ. The schedule range generator module (316) is operative to update the queue delay time. The web tracker module (320) and caller ID&V module (322) track session data to assist in calculations and perform identification and verification functions. The call generator module (324) is operable to place a customer in a queue in response to input from the customer. The selector icon editor (314) is operable to create the various versions of icons used to present callback delay information to customers. The web page icon will have been created in advance by the selector icon editor. Typically, a plurality of similar icons will be created to suit different conditions at the time of the inquiry. For example, icons may have been created specifically for display to sellers, buyers, and customers of unknown interest.

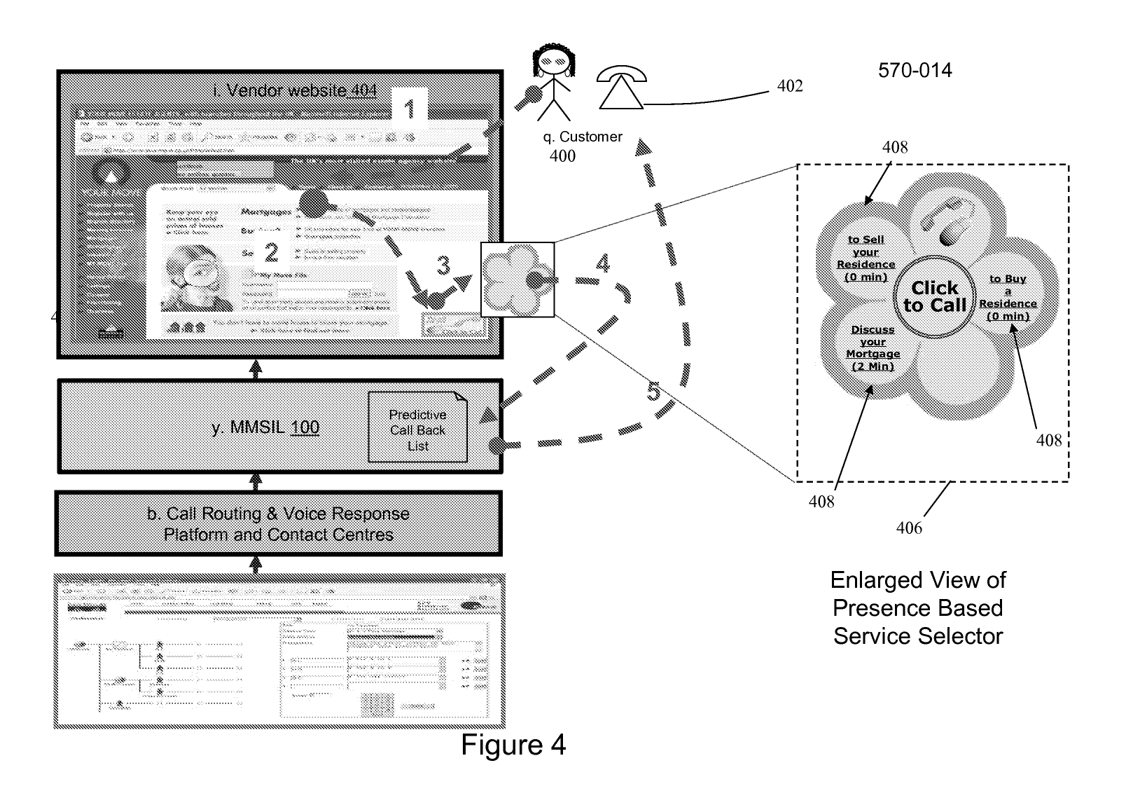

Referring now to FIGS. 2 through 5, a customer may initiate contact via any of various media types, and be provided with service via any of the available modes and media types, including combinations thereof. For example, a computer customer (400) may initiate a session with the web server (200) via the Internet (210) and be provided with service via the telephone (402). The web server (200) provides the selected pages to the application, e.g., browser (212), and also relays state and presence information to the service strategy server (200). For example, the web server will identify the specific customer to the strategy server if possible, and provide an indication to the strategy server of which web pages are being requested by that browser customer. The web server may also indicate to the strategy server other inputs from the browser, such as inputted data. Within the strategy server, the state information is received and stored in order to provide customized callback information, if needed. The customer navigates the website, selecting links and being supplied with HTML pages, in a conventional manner until another mode is triggered.

Customer intent to initiate a customer service session may be derived from various actions, including but not limited to, selected web pages, address book opening, and keyboard input, e.g., F1 application help or context sensitive help. If and when the customer indicates a desire for a customer service session, e.g., a callback or a desire to view callback service availability, the customer is presented with a web page (404) having an icon (406) that shows various types of available callback options (408). Contextual information can used to customize the service offering through web page (404), icon (406) and callback options (408) provided in response to the indication of intent. In particular, the contextual information can be utilized to tailor the service offering to the advantage of both the vendor and the customer. Contextual information about the customer may be obtained from various sources, including but not limited to, entry point, specifically selected links, session information, cookies, Google traces, in-flight transactions, and consumer identification. Contextual information can also come from personal information stored by the consumer. For example, if the consumer has a secure repository of personal information based on MS Cardspace, or MS Money, or a general directory, then this can be used to provide context. MS Cardspace provides a web-services security layer and web-services metadata exchange layer. This is the recorded customer owned customer data in FIG. 1 and the directory in customer application (218) in FIG. 2. Still further, the type of customer, e.g., buyer or seller, may be learned via customer login, cookie or specific inquiry. The icon (406) is selected from a plurality of related icons (500a, 500b, 500c) based at least in-part on customer type, if known, and on the contextual information. The selected icon (406) is then populated with current data by the dynamic selector generator module (318) based on both contextual information and the state of the corresponding service options. In the illustrated example, callback delay data may be presented for a given option only if there is a callback delay, thereby using service option state information. The callback delay may be explicit, e.g., minutes and seconds, or soft, e.g., “soon,” “later” and visual red, green and yellow indicators. Further, the customer may be assigned a priority based on factors calculated to achieve a particular customer service goal, e.g., maximize profits, thereby using contextual information to the advantage of the vendor. Icon (406) displays callback options associated with real estate transactions because the subject of real estate was indicated by the customer intent information. The “check your sale” option which shows a five minute callback delay is selected because contextual information indicated that the inquiry is a relatively low priority and it is therefore placed behind a contemporaneous inquiry from a potential new customer in a priority queue (the contemporaneous inquiry would be presented with a no-delay callback option).

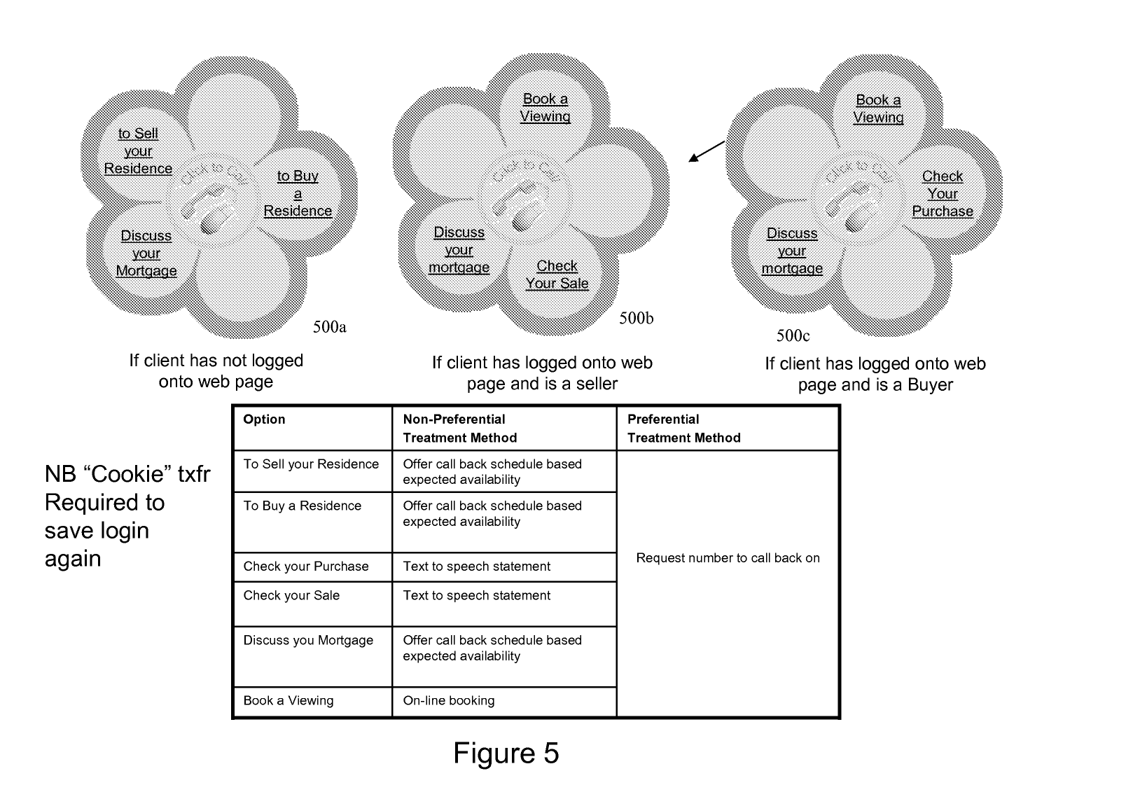

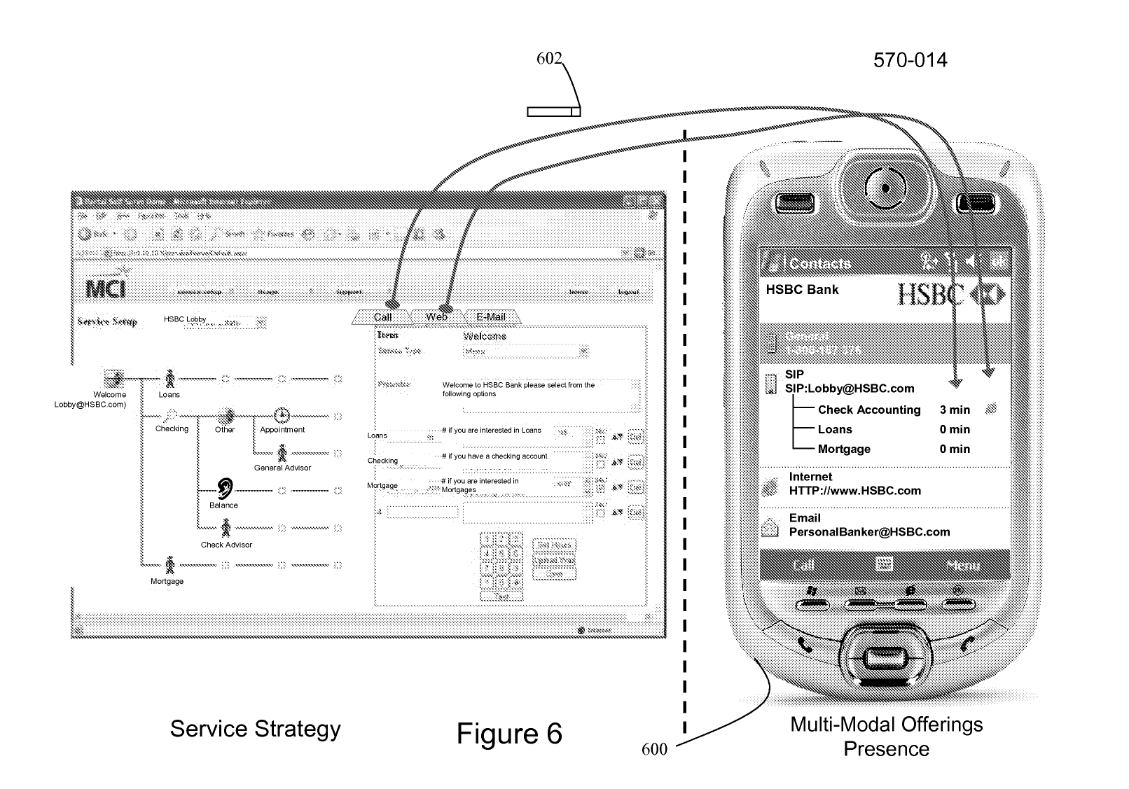

Referring to FIGS. 3 and 5, various techniques may be employed to enhance selection of service options for presentation, and to filter out service options to provide a practical number of remaining service options for display. In FIG. 5 there are only five available options to render. The best five options based on a calculation ƒ{context, available services, and time to service} are displayed. The variables of the function need not be equally weighted, and the particular function may be selected to achieve a desired result by placing particular emphasis on particular variables. Similar restrictions on screen real-estate would apply to the right hand side of FIG. 6 since it is generally undesirable to present an excessively long list. This functionality may be embedded in the selector rules (304) and dynamic selector generator module (318).

In response to selection of one of the callback options (408) by the customer, the customer is placed in a virtual callback queue in the callback log (312) by the call generator module (324). The telephone number of the customer may be obtained in any of various ways. For example, the customer may be prompted to provide a callback number or numbers and time of day constraints, or that information may be obtained from reference to a cookie on the customer's device, i.e., if the customer can be identified then information can be retrieved from a customer profile. Selected customer data including phone number is then provided to the call routing and voice response platform for use in establishing the callback and providing the customer service representative with information in order to avoid duplicative gathering of particular information.

It should be noted that although the illustrated example shows a callback as the service offering, other service offerings could be implemented with the MMSIL. For example, the MMSIL could be employed to present availability and time-to-delivery for purchases of products. Alternatively, the MMSIL could be employed to present availability and time-to-delivery of in-person services that require a representative to travel to the customer, customer's residence, or customer's equipment.

Referring now to FIG. 6, the callback service information may be delivered in a summary format to a device (600) specifically configured to receive the information in that format, and render the information in a particular manner. For example, rather than delivering an entire HTML page with an icon including a presentation of the data, the service strategy server may simply deliver the callback delay data with a tag (602) indicative of the service type. Since the device (600) is configured to interpret those tags, the data is presented to the customer on an interface that is produced by the customer device without reference to the server. The resulting display may therefore be substantially similar to that obtained via a browser. One advantage of this embodiment is that less network bandwidth is required for a given result.

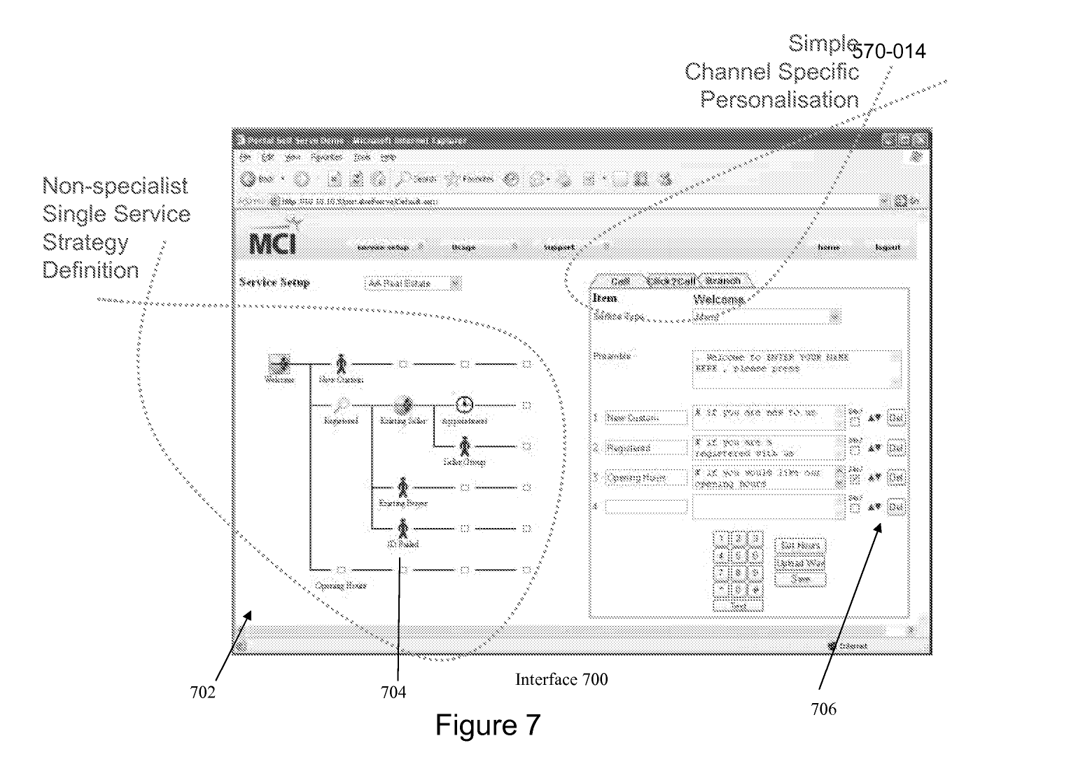

Referring now to FIG. 7, a graphic interface (700) may be employed to facilitate configuration of the customer interaction script for the callback service, or for when the customer initiates contact by telephone. Initially, a template may be selected having a basic format designed to suit a general service type. The left pane (702) is where packaged high value business modules (704) are put together. The right pane (706) is where the modules are personalised. In this application the initiating caller will be presented with a menu. If the caller selects “1,” the call will be directed to the advisors for new business. If the caller selects “2,” the caller will be presented with an identification stage that allows access for existing services. From the ‘new customer’ building block it's possible to configure the selection of who is available to answer the call. It is also possible to add and remove staff. For registered users who select “2” at the main menu a differentiated service can be provided. The caller is identified from the contact records stored in salesforce. The callers may also be segmented based on the value here stored in salesforce. There is a menu of high functional components from Caller identification and verification, menus, customer demographic segmentation, and appointment booking. Any slot in the left hand pane can be configured with any one of these business modules.

In one embodiment the right pane (706) includes conditional modal translation options. A mode of information delivery, e.g., audio, video, text, is somewhat independent of the media (provided the media is capable of delivery of that mode). Examples of modal translation include providing text to audio or audio to text translation for vision and hearing impaired customers, respectively. However, delivery mode options need not be limited to service of disabled customers, and may also be offered as a choice to suit the preferences of any customer.

While the invention is described through the above exemplary embodiments, it will be understood by those of ordinary skill in the art that modification to and variation of the illustrated embodiments may be made without departing from the inventive concepts herein disclosed. Moreover, while the preferred embodiments are described in connection with various illustrative structures, one skilled in the art will recognize that the system may be embodied using a variety of specific structures. Accordingly, the invention should not be viewed as limited except by the scope and spirit of the appended claims.

What is claimed is:

1. Apparatus for providing multi-media service to a client, comprising:
a first networked device operative to provide information capable of being rendered in human-understandable form by a second networked device; and
a contact center platform operative to facilitate establishment of communication between a representative and the client via a third networked device;
wherein at least some of the information provided by the first networked device includes an indication of available service options, and further includes an indication of delay associated with provision of one of those service options.

2. The apparatus of claim 1 wherein the contact center platform is operative in response to an indication of customer intent.

3. The apparatus of claim 1 wherein the representative is a non-human, automated response system.

4. The apparatus of claim 1 wherein the delay is indicative of time-to-delivery for purchase of a product.

5. The apparatus of claim 1 wherein the delay is indicative of time-to-delivery of in-person services.

6. The apparatus of claim 1 wherein the first networked device is operative to provide a service option page listing only those service options currently available.

7. The apparatus of claim 1 wherein the first networked device is operative to provide a service option page listing only those service options having a delay less than a predetermined threshold.

8. The apparatus of claim 1 wherein the first networked device is operative to identify the specific client.

9. The apparatus of claim 1 wherein the first networked device is operative maintain client-specific state information.

10. The apparatus of claim 9 wherein the first networked device is operative to provide a service option page having an icon selected from a plurality of icons based at least in-part on contextual information.

11. The apparatus of claim 10 wherein the first networked device is operative to populate the selected icon with current delay data based at least in-part on service offering state.

12. The apparatus of claim 11 wherein the delay data is further based on contextual information.

13. The apparatus of claim 12 wherein the icon includes callback options, and in response to selection of one of the callback options by the client, the first networked device is operative to place the client in a virtual callback queue in the contact center platform.

14. The apparatus of claim 13 wherein the first networked device is operative to prompt the customer to provide a callback number and time of day constraints.

15. The apparatus of claim 13 wherein the first networked device is operative to determine a callback number from reference to a cookie on the client's device.

16. The apparatus of claim 12 wherein the first networked device is further operative to provide customer-specific information to the contact center platform.

17. A computer program product, on computer readable media, for providing multi-media service to a client, comprising:
hosting logic executed by a first networked device operative to provide information capable of being rendered in human-understandable form by a second networked device; and
contact center logic operative to facilitate establishment of communication between a representative and the client via a third networked device;
wherein at least some of the information provided by the hosting logic includes an indication of service options available from the contact center logic, and further includes an indication of delay associated with provision of one of those service options.

18. The computer program product of claim 17 wherein the contact center logic is operative in response to an indication of customer intent.

19. The computer program of claim 17 wherein the representative is a non-human, automated response system.

20. The computer program computer program product of claim 17 wherein the delay is indicative of time-to-delivery for purchase of a product.

21. The computer program product of claim 17 wherein the delay is indicative of time-to-delivery of in-person services.

22. The computer program product of claim 17 wherein the hosting logic is operative to provide a service option page listing only those service options currently available.

23. The computer program product of claim 17 wherein the hosting logic is operative to provide a service option page listing only those service options having a delay less than a predetermined threshold.

24. The computer program product of claim 17 wherein the hosting logic is operative to identify the specific client.

25. The computer program product of claim 17 wherein the hosting logic is operative maintain client-specific state information.

26. The computer program product of claim 25 wherein the hosting logic is operative to provide a service option page having an icon selected from a plurality of icons based at least in-part on contextual information.

27. The computer program product of claim 26 wherein the hosting logic is operative to populate the selected icon with current delay data based at least in-part on service offering state.

28. The computer program product of claim 27 wherein the delay data is further based on contextual information.

29. The computer program product of claim 28 wherein the icon includes callback options, and in response to selection of one of the callback options by the client, the hosting logic is operative to place the client in a virtual callback queue in the contact center logic.

30. The computer program product of claim 29 wherein the hosting logic is operative to prompt the customer to provide a callback number and time of day constraints.

31. The computer program product of claim 29 wherein the hosting logic is operative to determine a callback number from reference to a cookie on the client's device.

32. The computer program product of claim 29 wherein the hosting logic is further operative to provide customer-specific information to the contact center.

33. Apparatus for providing multi-media service to a client, comprising:
a hosting device operative to provide tagged data;
a client device operable to render the tagged data in visual form based on tags; and
a contact center operative to facilitate establishment of communication between a representative and the client via telephone;
wherein the visually rendered data includes an indication of service options available from the contact center, and further includes an indication of delay associated with provision of one of those service options.

34. The apparatus of claim 33 wherein the delay is indicative of time-to-delivery for purchase of a product.

35. The apparatus of claim 33 wherein the delay is indicative of time-to-delivery of in-person services.

36. The apparatus of claim 33 wherein the hosting device is operative to provide a service option page listing only those service options currently available.

37. The apparatus of claim 33 wherein the hosting device is operative to provide service option data for only those service options having a delay less than a predetermined threshold.

38. The apparatus of claim 33 wherein the hosting device is operative to identify the specific client.

39. The apparatus of claim 33 wherein the hosting device is operative maintain client-specific state information.

40. The apparatus of claim 39 wherein the client device is operative to render a service option page having an icon selected from a plurality of icons based at least in-part on customer type.

41. The apparatus of claim 40 wherein the hosting device is operative to populate the selected icon with current delay data.

42. The apparatus of claim 41 wherein the icon includes callback options, and in response to selection of one of the callback options by the client, the hosting device is operative to place the client in a virtual callback queue in the contact center.

43. The apparatus of claim 42 wherein the host device is operative to prompt the customer to provide a callback number and time of day constraints.

44. The apparatus of claim 42 wherein the host device is operative to determine a callback number from reference to a cookie on the client device.

45. The apparatus of claim 42 wherein the host device is further operative to provide customer-specific information to the contact center.

46. A computer program product, on computer readable media, for providing multi-media service to a client, comprising:
hosting logic operative to provide tagged data;
client logic operable to render the tagged data in visual form based on tags; and
contact center logic operative to facilitate establishment of communication between a representative and the client via telephone;
wherein the visually rendered data includes an indication of service options available from the contact center, and further includes an indication of delay associated with provision of one of those service options.

47. The computer program product of claim 46 wherein the delay is indicative of time-to-delivery for purchase of a product.

48. The computer program product of claim 46 wherein the delay is indicative of time-to-delivery of in-person services.

49. The computer program product of claim 46 wherein the hosting logic is operative to provide a service option page listing only those service options currently available.

50. The computer program product of claim 46 wherein the hosting logic is operative to provide service option data for only those service options having a delay less than a predetermined threshold.

51. The computer program product of claim 46 wherein the hosting logic is operative to identify the specific client.

52. The computer program product of claim 46 wherein the hosting logic is operative maintain client-specific state information.

53. The computer program product of claim 52 wherein the client logic is operative to render a service option page having an icon selected from a plurality of icons based at least in-part on customer type.

54. The computer program product of claim 53 wherein the hosting logic is operative to populate the selected icon with current delay data.

55. The computer program product of claim 54 wherein the icon includes callback options, and in response to selection of one of the callback options by the client, the hosting logic is operative to place the client in a virtual callback queue in the contact center.

56. The computer program product of claim 55 wherein the host logic is operative to prompt the customer to provide a callback number and time of day constraints.

57. The computer program product of claim 56 wherein the host logic is operative to determine a callback number from reference to a cookie on the client device.

58. The computer program product of claim 55 wherein the host logic is further operative to provide customer-specific information to the contact center.

59. A computer program, stored on computer readable media, for facilitating configuration of a customer interaction script for a contact center, comprising:
logic for graphically displaying, in a first portion of a page, and accepting input indicative of direction of, incoming calls via a plurality of modules; and
logic for graphically displaying, in a second portion of the page, and accepting input indicative of configuration of individual ones of the modules.
